(19) United States
(12) Patent Application Publication
(10) Pub. No.: US 2023/0187676 A1
(43) Pub. Date: Jun. 15, 2023

(54) REDOX-FLOW BATTERY AND OPERATING METHOD

(71) Applicant: VOITH PATENT GMBH, Heidenheim (DE)

(72) Inventors: Klaus KRÜGER, Hüttlingen (DE); Thomas LÜTH, Freiburg (DE)

(73) Assignee: VOITH PATENT GMBH, Heidenheim (DE)

(21) Appl. No.: 17/925,860

(22) PCT Filed: May 28, 2021
(86) PCT No.: PCT/EP2021/064331

§ 371 Date: Nov. 17, 2022

(30) Foreign Application Priority Data
Jun. 10, 2020 (DE) 10 2020 115 385.6

(51) Int. Cl. H01M 8/18; H01M 8/04082; H01M 8/0432

(52) U.S. Cl. CPC H01M 8/188; H01M 8/04201; H01M 8/0432

(57) ABSTRACT

A redox-flow battery includes a cell arrangement and a tank device for holding electrolyte. The battery includes a measuring device for determining an open circuit voltage and a circulating module, and the measuring device for determining an open circuit voltage includes at least one measuring cell and at least four connections. One connection is provided for the supply of anolyte, one connection for the removal of anolyte, one connection for the supply of catholyte, and one connection for the removal of catholyte. The circulating module includes at least one pump head and at least two pump impellers, and the at least one measuring cell is integrated into the pump head. A connection of the measuring device is connected to a pressure side of a pump impeller, and the associated connecting line is integrated in the pump head.

The invention relates to a redox-flow battery and a method for operating a battery of this type. The battery can thereby be operated alone or as part of a battery system. A battery system of this type is composed, for example, of a series circuit of multiple redox-flow batteries (battery string).

A redox-flow battery comprises a cell arrangement, that is, an arrangement of a plurality of redox-flow cells, and a tank device for storing electrolyte with at least two tanks, wherein a first tank stores anolyte and a second tank stores catholyte. While the battery is in operation, anolyte and catholyte are pumped through the cells in two separate circuits. Two pump impellers, means for driving the pump impellers, and corresponding tubing are provided for this purpose. DE 10 2018 19 930 A1 discloses a redox-flow battery of this type, wherein the two pump impellers are driven together by a motor.

The object of the present invention is to improve the known redox-flow battery with regard to operational reliability and ease of maintenance.

The inventors have been guided by the observation that leakages in the electrolyte circuits are a frequent error event for conventional redox-flow batteries. As a result, the capacity of the battery decreases over time, and ultimately causes the battery to malfunction. Other potential error events are the failure of the drive means of the pump impellers. If the circulation of the electrolyte during operation of the battery malfunctions, the battery can be destroyed if operation of the same is not stopped in time.

According to the invention, the object is attained by an implementation in accordance with the independent device claim and the method claim. Other advantageous embodiments of the present invention can be found in the dependent claims.

The solutions according to the invention are explained below with the aid of drawings. Specifically, the drawings show:

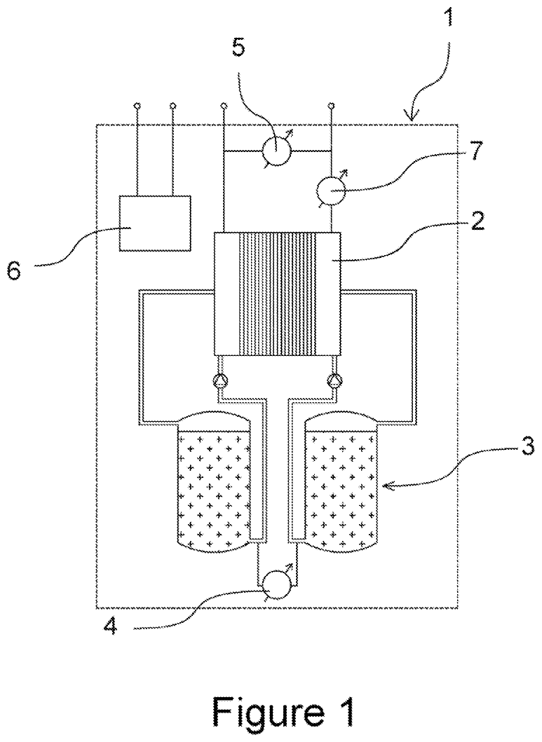

FIG. 1 Redox-flow battery

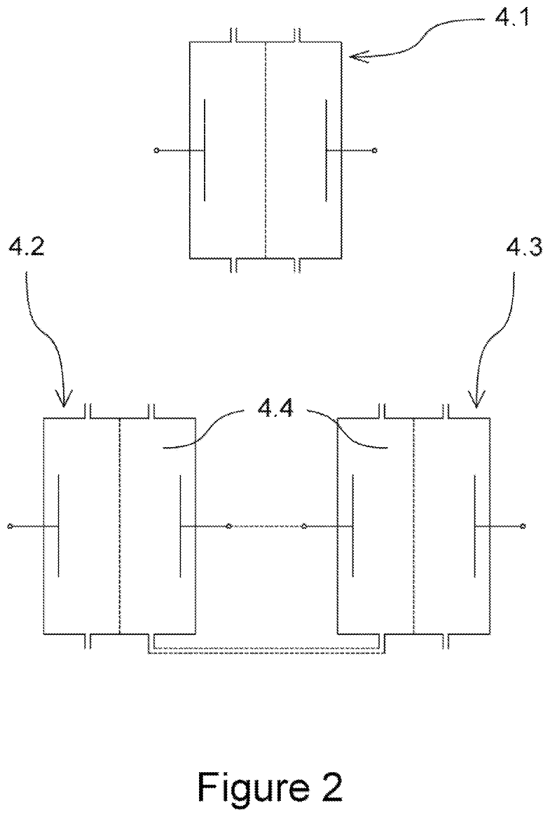

FIG. 2 Measuring devices for determining the OCV

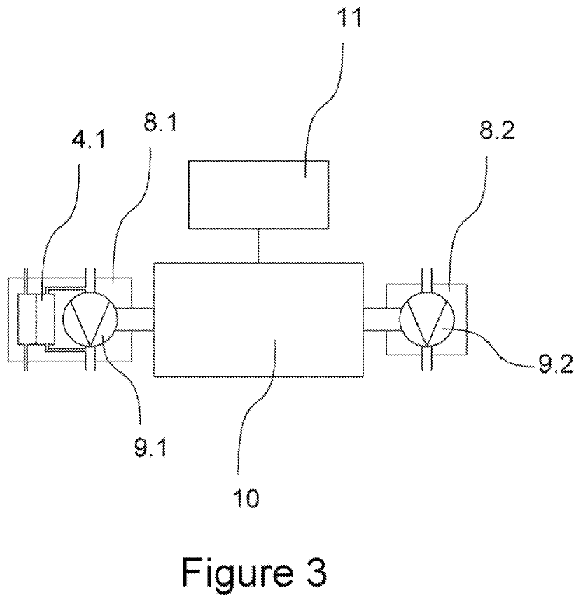

FIG. 3 Circulating module in a first embodiment

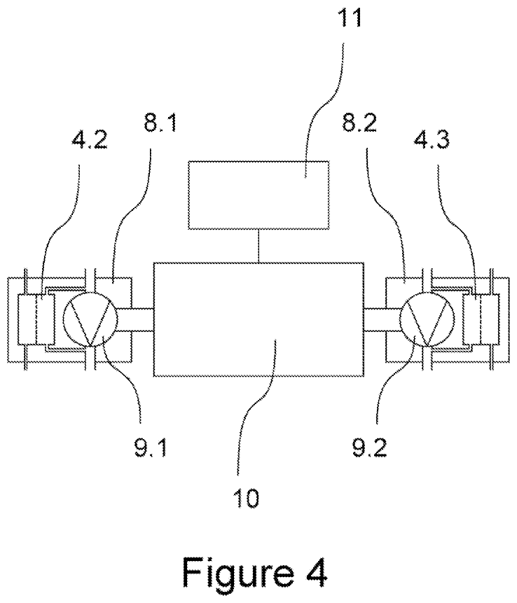

FIG. 4 Circulating module in a further embodiment

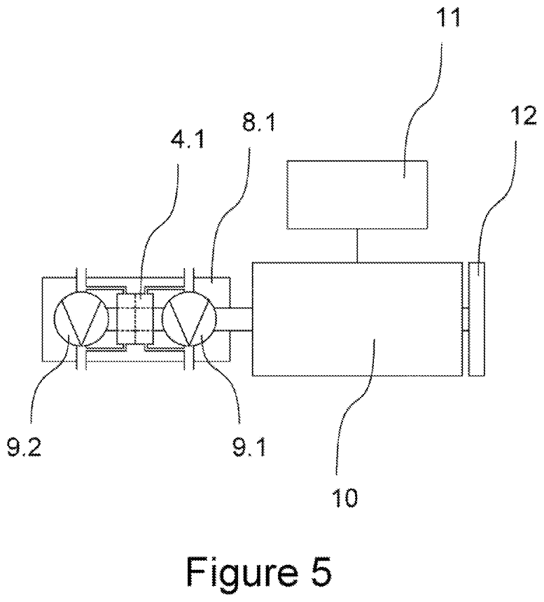

FIG. 5 Circulating module in a further embodiment

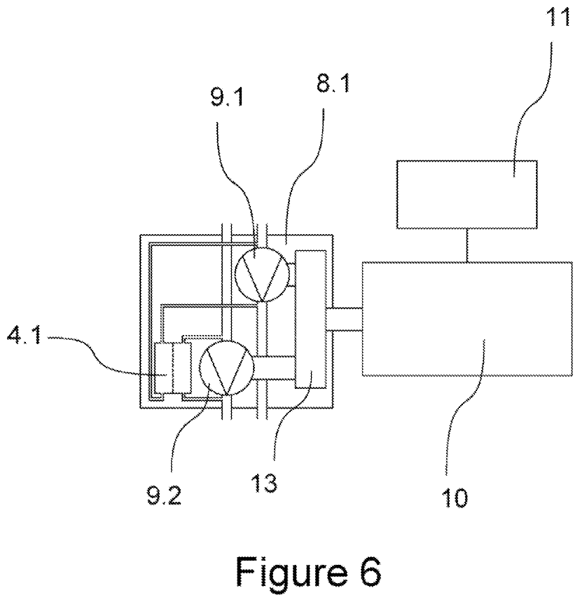

FIG. 6 Circulating module in a further embodiment

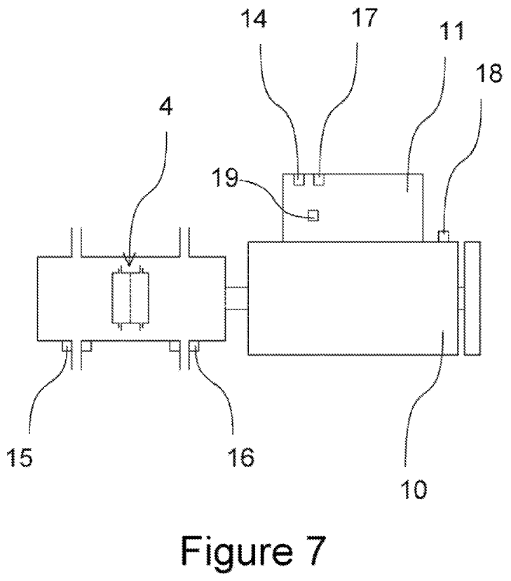

FIG. 7 Circulating module in a further embodiment

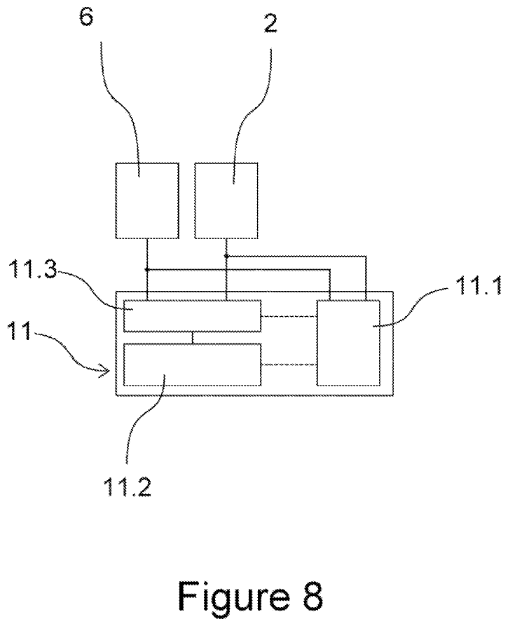

FIG. 8 Details for the power supply of a circulating module according to the invention

FIG. 1 Shows a redox-flow battery, which is denoted by 1. The battery comprises a cell arrangement, which is denoted by 2, and a tank device, which is denoted by 3. The cell arrangement 2 is an arrangement of a plurality of redox-flow cells that can be arranged in any desired manner. For example, this could be an individual cell stack, a series circuit of multiple stacks, a parallel circuit of multiple stacks, or a combination of serial and parallel circuits of multiple stacks. The tank device 3 is used to store electrolyte and to supply the cell arrangement 2 with electrolyte. For this purpose, the tank device 3 comprises at least two tanks for anolyte and catholyte, a tube system for connecting the tanks to the cell arrangement 2, and pump impellers for conveying the electrolyte. The battery 1 furthermore comprises a measuring device for determining what is referred to as the open circuit voltage (OCV), which measuring device is denoted by 4. The OCV value is a measure of the state of charge (SoC) of the batter module. The battery 1 additionally comprises an external power supply which is indicated by the rectangle with terminals and the denotation 6. The external power supply 6 is used, among other things, to feed the drive means of the pump impellers and a fan device that may be present, and the like.

The battery illustrated in FIG. 1 optionally comprises two other measuring devices, which are denoted by 5 and 7. The measuring device that is denoted by 5 is a measuring device for providing the terminal voltage of the cell arrangement 2, and therefore also of the battery 1. If the battery 1 is part of a battery system which is composed of a parallel circuit of multiple batteries 1, then all batteries 1 have the same terminal voltage, so that a shared measuring device 5 can be provided either in one of the batteries 1 or also outside of all batteries 1. The measuring device that is denoted by 7 is a measuring device for providing the charging and discharging current of the cell arrangement 2, and thus also of the battery 1. If the battery 1 is part of a battery system which is composed of a series circuit of multiple batteries 1, then all batteries 1 have the same charging and discharging current, so that a shared measuring device 7 can be provided either in one of the batteries or also outside of all batteries 1.

FIG. 2 shows two embodiments for a measuring device 4 for determining the OCV. The embodiment illustrated in the top part comprises a measuring cell that is denoted by 4.1. The measuring cell 4.1 is divided into two chambers by a membrane, which is also referred to as a separator. One electrode is respectively arranged in each chamber. The open circuit voltage can be tapped between the two electrodes. The measuring cell comprises four connections, wherein two connections each lead into each of the two chambers. One chamber is intended to hold anolyte, wherein one connection is intended for the supply and one connection for the removal of anolyte. The other chamber is intended to hold catholyte, wherein one connection is intended for the supply and one connection for the removal of catholyte. The embodiment illustrated in the bottom part of FIG. 2 comprises two measuring cells, which are denoted by 4.2 and 4.3. Each of the measuring cells is divided into two chambers h a membrane or separator, and one electrode is respectively arranged in each chamber. Of each of the measuring cells 4.2 and 4.3, one chamber each is provided for holding a reference liquid. These chambers are denoted by 4.4. The chambers 4.4 for holding reference liquid can be closed, meaning that the connections shown in the figure are sealed, once the reference liquid has been filled. The chambers 4.4 can also be connected to one another, as is indicated by the dashed line at the bottom. It is also possible to provide means by which the occasionally new reference liquid is introduced into the chambers 4.4, wherein the used reference liquid is conducted out of the chambers 4.4. The other two chambers each have two connections, wherein one of these chambers is intended to hold anolyte, and wherein one connection is intended for the supply and one connection for the removal of anolyte. The other chamber is intended to hold catholyte, wherein one connection is intended for the supply and one connection for the removal of catholyte. The electrodes of the chambers that are intended to hold the reference liquid can be connected to one another, as illustrated by the dashed line in FIG. 2, so that the open circuit voltage can be tapped directly between the remaining electrodes. Alternatively, the illustrated connection of the middle electrodes can be omitted, and one partial voltage each can be tapped between the two electrodes of each cell. The open circuit voltage then results from the sum of the two partial voltages. If the two partial voltages deviate from one another in terms of amount, it is possible to conclude from the deviation the presence of a displacement in the electrolyte of the battery. A displacement of this type can result from an undesirable effect that is referred to as “crossover.” The possibility of detecting a displacement of this type makes the embodiment illustrated at the bottom of FIG. 2 particularly advantageous.

Common to both embodiments is that the measuring device 4 for determining the open circuit voltage comprises at least one measuring cell and at least four connections, wherein one connection is provided for the supply of anolyte, one connection for the removal of anolyte, one connection for the supply of catholyte, and one connection for the removal of catholyte.

In order for a measuring device 4 to be able to reliably determine the actual open circuit voltage of the battery, the chambers provided for anolyte and catholyte must be supplied with new electrolyte. This occurs in that the measuring device is integrated into the electrolyte circuit. The connections for the supply and removal of electrolyte are thereby connected to points of the electrolyte circuit that have a pressure difference such that electrolyte can flow through the chambers of the measuring device 4. Suitable branch points with high pressure ware located in the lines that extend from the pressure side of the pump impellers to the cell arrangement. Suitable branch points with low pressure are located in the lines that extend from the tanks to the suction side of the pump impellers or from the cell arrangement to the tanks. Furthermore, low pressure is present in the upper section of the tanks themselves, so that the connections for the removal of electrolyte of the measuring device 4 can also be connected to this section of the tanks. The inventors have found that particularly the connections for the supply of electrolyte and the lines connected thereto are susceptible to leakage, since a higher internal pressure is present there than at the connections for the removal of electrolyte and the lines connected thereto.

A redox-flow battery according to the invention comprises a circulating module that is embodied such that it can circulate anolyte and catholyte. Because the output amount depends on the operating state of the battery, the circulating module has a variable-speed drive. The circulating module can be supplied externally with power. The external power supply 6 can thereby be a direct current or alternating current connection. Alternatively, the circulating module can also be internally supplied with power. These options are described in detail in connection with FIG. 8.

FIG. 3 shows a circulating module in a first embodiment in schematic illustration. The circulating module comprises at least one first pump impeller for circulating anolyte, which is denoted by 9.1, and at least one second pump impeller for circulating catholyte which is denoted by 9.2. In FIG. 3, each pump impeller is arranged in one pump head each, which pump heads are denoted by 8.1 and 8.2. The circulating module furthermore comprises a variable-speed electric motor that is denoted by 10 and is connected to the pump impellers 9.1 and 9.2 such that it can simultaneously drive stud impellers. In FIG. 3, the connection to the pump impellers is realized by means of a shaft which protrudes out of the motor 10 on both sides motor with full-length shaft or with double shaft). One pump impeller each is connected to one shaft end each. Since the electrolyte normally must not be allowed to come into contact with metal in redox-flow batteries, a magnetic coupling can be arranged respectively between the shaft and pump impeller. For the sake of clarity, magnetic couplings of this type are not illustrated in FIG. 3 and the subsequent figures. Magnetic couplings of this type can thereby be integrated in the respective pump head. Pump heads and pump impellers are normally mark of plastic, for example of polypropylene (PP). The pump heads can thereby be milled from PP blocks as two half shells, for example. Alternatively, half shells of this type can also be produced as injection-molded parts. The circulating module furthermore comprises a control and feed device which is denoted by 11 and which is embodied and connected to the electric motor 10 such that it can feed said motor with an alternating current at a variable frequency. For this purpose, the control and feed device normally comprises a control unit and a feed unit, that is, a frequency converter, which can both be integrated on a printed circuit board. Depending on whether the external power supply 6 is an alternating current or direct current supply, this will be an AC/AC or DC/AC converter.

If the two pump impellers are embodied in an identical manner, then the output rate of anolyte equals the output rate of catholyte. This equivalence of the output rates is necessary for some redox-flow batteries, such as vanadium-based batteries for example. Other batteries require output rates at a ratio deviating from 1:1. This can be achieved either in that the pump impellers have different output amounts per revolution, or in that a gear mechanism with corresponding reduction is inserted between at least one pump impeller and the motor.

The circulating module shown in FIG. 3 comprises a measuring cell that is denoted by 4.1. A first connection of the measuring cell 4.1 is thereby connected to the pressure side of the pump impeller 9.1, and a second connection of the measuring cell 4.1 is connected to the suction side of the pump impeller 9.1, wherein the stated connections lead into the same chamber of the measuring cell 4.1, and both the measuring cell 4.1 and also the stated connections are integrated into the pump head 8.1 associated with the pump impeller 4.1. Because the measuring cell 4.1 and the connecting lines for the pressure and suction side of the pump impeller 9.1 are integrated in the pump head 8.1, the susceptibility of the battery to leakage is reduced, since external lines with corresponding flanging are omitted, which lines exhibit a higher susceptibility to leakage than the connections integrated in the pump head according to the invention, which connections can advantageously be embodied as channels that run in the pump head. However, to achieve a large portion of the positive effect described according to the invention, it is sufficient if only the line that leads to the pressure side of the pump impeller 9.1 is integrated in the pump head, since said line is more susceptible to leakage than the line which removes electrolyte from the corresponding chamber of the measuring cell 4.1. The latter line could also be connected to a different low-pressure point of the electrolyte circuit (see the explanations above regarding FIG. 2). Thus, according to the invention, it is sufficient it a (first) connection of the measuring cell 4.1 is connected to the pressure side of the pump impeller 9.1 and if the associated line is integrated in the pump head 8.1. It is particularly advantageous if a further (second) connection is connected to the suction side of the pump impeller 9.1 and if the associated lint is also integrated in the pump head 8.1. This also applies correspondingly to the other embodiments of the circulating module described further below.

The measuring cell 4.1 illustrated in FIG. 3 is thereby part of a measuring device 4 according to the upper embodiment of FIG. 2. The connections of the measuring cell 4.1 that are illustrated as being open in FIG. 3 are thereby connected to the circuit associated with the other pump head 8.2 such that electrolyte from said circuit can flow through the corresponding chamber (that is, the left chamber) of the measuring cell 4.1. For the sake of clarity, these lines are not illustrated in FIG. 3. The pump head 8.2 can thereby provide suitable connections that are connected to the pressure and suction side of the pump impeller 9.1. This connection can also be configured in a different manner, however. Since the two pump heads 8.1 and 8.2 are arranged close to one another, the farmer option is particularly advantageous and can be advantageously realized by means of lines running in a fixed manner along the motor housing. The embodiment according to FIG. 3 can also comprise another measuring cell 4.1 according to the upper embodiment from FIG. 2, which measuring cell 4.1 is integrated in the pump head 8.2. As a result, the measuring device 4 has a redundant design, so that if one of the measuring cells 4.1 fails, the battery can still continue to be operated.

FIG. 4 shows a circulating module in a further embodiment. The associated battery thereby comprises a measuring device 4 according to the lower embodiment from FIG. 2. One of the measuring cells 4.2 and 4.3 each, together with the connections for the respective pressure and suction sides of the pump impellers 9.1 and 9.2, is thereby integrated in each of the two pump heads 8.1 and 8.2. What was said in regard to the bottom of FIG. 2 thereby applies to the connections, illustrated as being free in FIG. 4, for the chambers of the measuring cells 4.2 and 4.3 filled with the reference liquid.

FIG. 5 shows a circulating module in a further embodiment. The associated battery thereby comprises a measuring device 4 according to the upper embodiment from FIG. 2. In contrast to the embodiments according to FIGS. 3 and 4, the two pump impellers 9.1 and 9.2 are arranged in a shared pump head, which is denoted by 8.1. The pump impellers 9.1 and 9.2, are connected to one another such that when the motor 10 drives one of the pump impellers, it also drives the other in tandem. The measuring cell 4.1 is integrated in the pump head 8.1 such that all lines for the measuring cell 4.1 run inside of the pump head 8.1. The embodiment illustrated in FIG. 5 therefore requires even fewer external connecting lines than the embodiment according to FIG. 3.

FIG. 5 additionally shows a fan, which is denoted by 12. This is an external fan that is connected to the axle of the motor 10. The inventors have found that a frequent cause for a malfunction of the motor 10 is that a blade of the fan breaks off. If the motor comprises an integrated fan, then the entire motor must be exchanged for the repair. With an external fan, it is sufficient to exchange the fan itself. An external fan of this type can also be used with all other embodiments described. If necessary, the fan must thereby be arranged laterally on the motor and have its own drive.

FIG. 6 shows a circulating module in a further embodiment. The associated battery thereby comprises a measuring device 4 according to the upper embodiment from FIG. 2. The embodiment according to FIG. 6 differs from the embodiment according to FIG. 5 in that the pump impellers 9.1 and 9.2 are connected to one another by means of a gear mechanism, which is denoted by 13. This is a gear mechanism with one input shaft and two output shafts. The motor 10 is connected to the input shaft. A gear mechanism 13 of this type can also be advantageously combined with the embodiments according to FIGS. 3 and 4 so that said embodiments can also be realized with a motor having a motor shall that only protrudes on one side.

The embodiments according to FIGS. 5 and 6 can also be advantageously embodied with measuring devices 4 according to the lower embodiment of FIG. 2, that is, with two cells 4.2 and 4.3 each integrated m the pump head 8.1. In addition, all embodiments can, in principle, also be embodied with two motors, so that one motor each drives one pump impeller each. However, it is of course more cost-efficient if only one motor that simultaneously drives both pump impellers is used.

FIG. 7 shows a circulating module in a further embodiment. FIG. 7 thereby shows all sensors or acquisition units necessary and/or advantageous (that is, optional) or the control of a circulating module according to the invention, which sensors or acquisition units supply the input parameters for controlling the speed of the motor 10 to the control and feed device 11. The illustration from FIG. 7 thereby uses the embodiment according to FIG. 5, with some details having been omitted for the sake of clarity. The application to all other embodiments poses no difficulty whatsoever for the person skilled in the art. Necessary input parameters are the OCV value, which is determined by the measuring device 4, and the charging and discharging current, which is determined by the measuring device 7. All sensors or acquisition units are connected to the control and feed device 11 such that the acquired measured values can be transmitted to said device. For the sake of clarity, FIG. 7 does not show these connections. Optional sensors or acquisition units are pressure sensors, one of which is denoted by 15, temperature sensors for measuring the temperature of the electrolyte, one of which is denoted by 16, a temperature sensor for measuring the winding temperature of the motor 10, which is denoted by 18, and a vibration sensor for measuring vibration caused by the motor 10, which is denoted by 19. Vibration sensors are understood as meaning all types of sensors that are capable of detecting vibrations. This includes, for example, acceleration sensors (mm/s²) and vibration velocity sensors (mm/s). Temperature sensors 16 for measuring the temperature of the electrolyte are particularly important if the battery 1 and the surrounding environment of the battery 1 are not temperature controlled, as a result of which the temperature of the battery 1 follows the temperature fluctuations of the surrounding environment. Some batteries 1 therefore also have a cooling system that comprises an electrolyte/air heat exchanger, for example. Temperature fluctuations affect the viscosity of the electrolyte. In addition, the internal resistance of the cells is subject to a high temperature dependency.

The pressure sensors 15 are used to measure the pressure in the electrolyte-conveying lines on the pressure side of the pinup impellers 9.1 and 9.2. These sensors are therefore arranged on the corresponding lines on the outside of the pump head in FIG. 7. They could also be integrated in the pump head or also attached to the lines at a distance from the pump head. In any case, the proximity to the pump head has the advantage that the hues between the sensors 15 and the control and feed device 11 are short. The same thing applies to the temperature sensors 16. These could just as easily be arranged on the suction side of the pump impellers. The temperature sensor 18 is arranged on the outside of the motor housing in FIG. 7. It is thereby located in the proximity of the power connections of the motor and can thus reliably acquire the winding temperature. It could also be integrated in the motor or be located in the control and feed device 11.

The control and feed device 11 furthermore comprises an input for the charging and discharging current, which is denoted by 14, and an input for the terminal voltage, which is denoted by 17. If the associated measuring devices 5 and/or 7 are part of the battery 1, then the stated inputs accommodate the associated connecting lines for said measuring devices so that the control and feed device 11 can receive the associated measured values. If the associated measuring devices 5 and/or 7 are arranged outside of the battery 1, then the acquired measured values are normally transmitted with the aid of a communication bus. In the latter case, the inputs 14 and/or 17 accommodate the connecting line for the communication bus. The inputs 14 and 17 can thereby also form a single input that is connected to the communication bus.

FIG. 7 additionally differs from FIG. 5 in that the control and feed device 11 is connected directly to the motor 10. The advantage of this arrangement is the compactness, which also makes it possible to keep all connecting lines short. In addition, the vibration sensor 19 can then be arranged inside the control and feed device 11, since vibrations generated by the motor 10 are transmitted to the control and feed device 11. However, it could also be arranged on or in the motor 10.

A circulating module according to the invention can also comprise other optional sensors not illustrated in FIG. 7, such as flow sensors in both electrolyte lines or a structure-born noise sensor on the motor 10, for example. A photometric measuring cell, with which UV/vis spectra can be registered, can additionally be integrated in a pump housing.

FIG. 8 shows, in schematic illustration, details of a circulating module according to the invention in relation to the power supply. It is thereby possible to switch between an external and internal power supply. The embodiment according to FIG. 8 thereby requires that the external power supply 6 be based on direct current. The control and feed device 11 comprises a control unit which is denoted by 11.1, a feed unit which is denoted by 11.2, and a relay which is denoted by 11.3. In principle, the units 11.1, 11.2, and 11.3 can also be embodied separately, so that in this case the control and feed device 11 only constitutes a functional (and thus conceptual) unit. The control unit 11.1 is normally a microcontroller. The feed unit 11.2 is a DC/AC frequency converter which is connected to the relay 11.3 on the DC side, and which is connected to the motor 10 on the AC side (not illustrated in FIG. 8). The DC/AC frequency converter is thereby preferably designed for a DC input voltage of 35 to 80 volts. The control lines by which the control unit 11.1 is respectively connected to the feed unit 11.2 and the relay 11.3 are indicated by the dashed lines in FIG. 8. The control unit 11.1 thereby controls the switching state of the relay 11.3 and the frequency of the AC side of the feed unit 11.2 (and thus the speed of the motor 10). The relay 11.3 is connected to the external power supply 6 and to the cell arrangement 2 such that the control unit 11.1 can switch between the external power supply and the internal power supply (from the cell arrangement 2) of the feed unit 11.2 in that it controls the switching state of the relay 11.3 accordingly. The control unit 11.1 is respectively connected to the external and the internal power supply. For this purpose, the control unit 11.1 comprises two separate DC/DC converters that are interconnected such that an isolated supply of electricity to the control unit 11.1 results, wherein the control unit 11.1 can in this manner be supplied with power both internally and also externally. Which power supply is thereby used in each case is determined internally by the control unit 11.1 wherein it is, of course, advantageous if the control unit 11.1 is supplied internally precisely when the feed unit 11.2 is also supplied internally.

The switching of the power supply between the external and internal power supply by the control unit 11.1 thereby takes place in the following manner. First, the output of the feed unit 11.2 is reduced, wherein the motor 10 continues to rotate in a braked manner due to the inertia thereof. The relay 11.3 is then switched, which can take place in a currentless or nearly currentless manner. Finally, the output of the feed unit 11.2 is raised again. In order for it to be possible to avoid sudden changes in voltage at the input of the feed unit 11.2 during the switching, one or more low-pass elements interconnected accordingly can be provided.

The capability of switching between an external and internal power supply has the following advantages:
black-start capability (internal power supply)
pre-charging of the battery (external power supply)
efficiency optimization (or for reducing the load of the main output path when the battery is being discharged)

If the battery is part of a higher-level battery system, for example a battery string, additional advantages result in that the switching between the internal and external power supply is used for balancing or at the margins of the state of charge. The terminal voltages of the individual batteries can thereby be used as a control variable for the balancing, for example.

The method for operating a battery according to the invention comprises the fallowing steps:
acquiring measured values
determining a frequency from the acquired measured values
feeding the motor with an alternating current at the determined frequency

The operating method thereby ensures that a sufficient amount of electrolyte per unit of time flows through the cell arrangement. When the frequency necessary therefor is determined in the second step, the charging and discharging current (in terms of amount and sign) and the OCV value are used as measured values in each case. If temperature fluctuations of the electrolyte can be expected, that is, if the battery is not temperature controlled, then the temperature of the electrolyte is additionally used as a measured value to determine the frequency. The characteristic curves of the pump impellers also enter into the determination. The determination of the frequency can thereby take place with the aid of tables or via a function.

The method can additionally comprise the following step:
outputting an error code if acquired measured values lie outside of a predefined range

The output of the error code is thereby intended to ensure that the battery is not operated in a state which can result in damage to the battery. This would be the case, for example, if a sufficient amount of electrolyte per unit of time were not flowing through the cell arrangement. This case can occur, for example, if the motor is not functioning or not properly functioning. In such a case, for example, the vibration sensor would supply a value that lies above a predefined threshold value, or a pressure sensor would supply a value that lies below (motor failure) or above (blockage in the electrolyte circuit) predefined threshold values, or the temperature sensor for acquiring the winding temperature would supply a value that lies above a predefined threshold value. This applies analogously to flow sensors and structure-born noise sensors. In general, the predefined threshold values mentioned can also depend on parameters, such as the operating parameters of the battery for example, so that the threshold values are variable and a function of said parameters.

The method can additionally comprise the following step:
switching between an external and internal power supply of the circulating module

The switching thereby occurs by a change in the switching state of the relay 11.3. Normally, switching is thereby carried out to the external power supply during charging and to the internal power supply during discharging. As a result, as high efficiency is achieved during charging and there is a lower load on the main output path of the battery during discharging. However, a switching can also take place upon an external control signal, wherein it is not necessary to adhere to the rule established above in this case. This can be advantageous where the battery is part of a higher-level battery system (see above).

### LIST OF REFERENCE NUMERALS

1 Redox-flow battery
2 Cell arrangement
3 Tank device
4 Measuring device for determining the OCV
4.1 Measuring cell
4.2 Measuring cell
4.3 Measuring cell
4.4 Reference liquid
5 Measuring device for determining the terminal voltage
6 External power supply
7 Measuring device for determining the charging and discharging current
8.1 Pump head
8.2 Pump head
9.1 Pump impeller
9.2 Pump impeller
10 Electric motor
11 Control and feed device
11.1 Control unit
11.2 Feed unit

### 11.3 Relay

### 12 Fan

13 Gear mechanism
14 Input for charging and discharging current
15 Pressure sensor
16 Temperature sensor
17 Input for terminal voltage
18 Temperature sensor
19 Vibration sensor

1. A redox-flow battery comprising a cell arrangement and a tank device for holding electrolyte, wherein the cell arrangement comprises a plurality of redox-flow cells and the tank device comprises at least one first tank for holding anolyte, at least one second tank for holding catholyte, and a tubing system for connecting the tanks to the cell arrangement, and wherein the battery comprises a measuring device for determining an open circuit voltage and a circulating module that is embodied such that it can circulate anolyte and catholyte, and wherein the measuring device for determining an open circuit voltage comprises at least one measuring cell and at least four connections, wherein one connection is provided for the supply of anolyte, one connection for the removal of anolyte, one connection for the supply of catholyte, and one connection for the removal of catholyte, and wherein the circulating module comprises at least one pump head and at least two pump impellers, and wherein at least one pump impeller is arranged in the at least one pump head, characterized in that the at least one measuring cell is integrated in the pump head, and wherein a connection of the measuring device is connected to a pressure side of the pump impeller arranged in the pump head, and wherein the associated connecting line is integrated in the pump head.

2. The redox-flow battery according to claim 1, wherein a further connection of the measuring device is connected to a suction side of the pump impeller arranged in the pump head, and wherein the associated connecting line is integrated in the pump head.

3. The redox-flow battery according to claim 1, wherein the circulating module comprises two pump heads with one pump impeller each, and the measuring device for determining an open circuit voltage comprises two measuring cells, and wherein one of the measuring cells each is integrated in each of the pump heads.

4. The redox-flow battery according to claim 1, wherein the circulating module comprises exactly one pump head with two pump impellers.

5. The redox-flow battery according to claim 4, wherein the measuring device for determining an open circuit voltage comprises two measuring cells, and wherein both measuring cells are integrated in the pump head.

6. The redox-flow battery according to claim 1, wherein the circulating module comprises a variable-speed electric motor that is connected to the pump impellers such that it can drive said impellers simultaneously, and wherein the circulating module comprises a control and feed device that is embodied and connected to the electric motor such that it can feed said motor with an alternating current at a variable frequency.

7. The redox-flow battery according to claim 6, wherein the control and feed device is connected directly to the motor.

8. The redox-flow battery according to claim 6, wherein the control and feed device comprises an input for the charging and discharging current of the battery.

9. The redox-flow battery according to claim 6, wherein the control and feed device comprises an input for the terminal voltage of the battery.

10. The redox-flow battery according to claim 6, wherein the circulating module comprises one or more of the following elements: pressure sensor, temperature sensor for measuring the temperature of the electrolyte, temperature sensor for measuring the temperature of the winding of the electric motor, vibration sensor, flow sensor, structure-borne noise sensor.

11. The redox-flow battery according to claim 6, wherein the battery comprises an external direct current supply and the control and feed device comprises a control unit, a feed unit, and a relay, and wherein the feed unit is embodied as a DC/AC frequency converter that is connected to the relay on the DC side and to the electric motor on the AC side, and wherein the control unit is connected to the relay such that the control unit can determine the switching state of the relay, and wherein the control unit is connected to the feed unit such that the control unit can determine the frequency of the AC side of the feed unit and wherein the relay is connected to the external direct current supply and to the cell arrangement such that, depending on the switching state of the relay, the feed unit is connected either to the external direct current supply or to the cell arrangement, and wherein the control unit is respectively connected to the external direct current supply and to the cell arrangement.

12. A method for operating a redox-flow battery according to claim 8, wherein the method comprises:
acquiring measured values;
determining a frequency from the acquired measured values;
feeding the motor with an alternating current at the determined frequency;
wherein the open circuit voltage and the charging and discharging current are used as measured values, and wherein both the amount and the sign of the current are used for the charging and discharging current.

13. The method according to claim 12 for operating a redox-flow battery, wherein the method comprises:
outputting an error code if acquired measured values lie outside of a predefined range.

14. The method according to claim 12 for operating a redox-flow battery, wherein the method comprises:
changing the switching state of the relay;
wherein the switching state of the relay is chosen such that the feed unit is connected to the external direct current supply during charging and the feed unit is connected to the cell arrangement during discharging.

15. The method according to claim 12 for operating a redox-flow battery, wherein the method comprises:
changing the switching state of the relay;
wherein the switching state of the relay follows an external control signal.
